(19) United States
(12) Patent Application Publication
(10) Pub. No.: US 2020/0000062 A1
(43) Pub. Date: Jan. 2, 2020

(54) BAND-LIKE BODY

(71) Applicant: Unicharm Corporation, Ehime (JP)

(72) Inventors: Daisuke Komatsubara, Kanonji-shi (JP); Hiroki Yamamoto, Kanonji-shi (JP)

(73) Assignee: Unicharm Corporation, Ehime (JP)

(21) Appl. No.: 16/465,454

(22) PCT Filed: Aug. 31, 2017
(86) PCT No.: PCT/JP2017/031473

§ 371 Date: May 30, 2019

(30) Foreign Application Priority Data
Nov. 30, 2016 (JP) 2016-233524

(51) Int. Cl. A01K 23/00

(52) U.S. Cl. CPC A01K 23/00

(57) ABSTRACT

A belt-shaped body includes: a torso-facing surface that faces the torso of the animal when the belt-shaped body is worn; a non-torso-facing surface on an opposite side from the torso-facing surface; a first region extending between one side edge in a lengthwise direction and a center region and that corresponds to a dorsal region of the animal when the belt-shaped body is worn; a second region extending between another side edge in the lengthwise direction and the center region; a first engagement section that is disposed on the torso-facing surface of the first region; a second engagement section that is disposed on the non-torso-facing surface of the second region; and a gripping part that has a length in the lengthwise direction such as to allow gripping between the one side edge and the first engagement section.

### FIELD

The present invention relates to a belt-shaped body to be used in an absorbent article for an animal, such as a disposable diaper for a pet.

### BACKGROUND

Among absorbent articles for animals, for treatment of excreta that have been excreted by pets such as dogs, there are known types that comprise a band-like belt that is fitted by wrapping around the torso of the pet, and a disposable diaper that is disposed on the lower crotch region of the pet and anchored in a freely detachable manner to the belt.

As an example of such an absorbent article for an animal, PTL 1 discloses a two-part paper diaper for a bedridden pet, comprising a belt of a stretchable member that is initially wrapped around the torso of a pet, and a diaper body provided with an absorbent body having a structure that is raised at angles at both flanks, wherein the stretchable member used has perforations formed at the front part of the diaper body, and is divided into slits at the rear part of the diaper body. The paper diaper for a pet disclosed in PTL 1, which uses a stretchable member that is divided at the front part and rear part of the diaper body, can follow alterations in the right-left balance of the body shape when the pet lies on its side, and can prevent side leakage of urine or feces by the absorbent body having the structure with angles at both flanks.

### CITATION LIST

### Patent Literature

[PTL 1] Japanese Unexamined Patent Publication No. 2006-122039

### SUMMARY

### Technical Problem

However, with an absorbent article for an animal comprising a belt (belt-shaped body) for anchoring of a diaper body (lower crotch member), as with the pet paper diaper disclosed in PTL 1, when the belt-shaped body is wrapped around the torso of a pet such as a dog, the pet may exhibit dissatisfaction and move, making it difficult to fit the belt-shaped body onto the torso of the pet with sufficient tightening force. If the belt-shaped body is not fitted onto the torso of the pet with sufficient tightening force, the belt-shaped body shifts from the proper position by movement of the animal, and as a result, the lower crotch member anchored to the belt-shaped body will be less likely to be properly fitted onto the lower crotch of the pet, such that excreta such as urine that have been discharged from the pet may leak from the lower crotch member.

It is therefore an object of the present invention to provide a belt-shaped body that allows a lower crotch member such as a disposable diaper to be accurately contacted with the lower crotch of an animal, wherein excreta such as urine that have been excreted from the animal are less likely to leak from the lower crotch member.

### Solution to Problem

One aspect (aspect 1) of the invention is a belt-shaped body that has a lengthwise direction corresponding to a direction around a torso of an animal and a widthwise direction corresponding to a front-rear direction of the animal, and is reusable for anchoring of a lower crotch member that is to be disposed at a lower crotch of the animal, in a freely detachable manner,

the belt-shaped body having a torso-facing surface that faces the torso of the animal when it is worn, and a non-torso-facing surface on an opposite side from the torso-facing surface, while also having a center region located at a center in the lengthwise direction and corresponding to an abdominal region of the animal when it is worn, a first region extending between one side edge in the lengthwise direction and the center region and corresponding to a dorsal region of the animal when it is worn, and a second region extending between the other side edge in the lengthwise direction and the center region and corresponding to the dorsal region of the animal when it is worn, and

the belt-shaped body comprising a first engagement section that is disposed on the torso-facing surface of the first region, a second engagement section that is disposed on the non-torso-facing surface of the second region and is able to engage with the first engagement section, and a gripping part that has a length in the lengthwise direction such as to allow gripping between one side edge in the lengthwise direction and the first engagement section, and that does not engage with the second engagement section.

Throughout the present description, the term “reusable belt-shaped body” refers to a belt-shaped body that can be formed in a state allowing its reuse by washing and drying in a washing machine or the like, when the belt-shaped body fitted on an animal has been soiled by excreta or sweat of the animal or other contaminants.

Also throughout the present description, “a length in the lengthwise direction such as to allow gripping” means a length in the lengthwise direction that is sufficient to allow a person (such as an owner) fitting the belt-shaped body onto the torso of the animal, to steadily grip the edge in the lengthwise direction of the belt-shaped body with the finger pads of the thumb and forefinger of one hand, and to apply the necessary force for movement or adjusting the tightening force while maintaining the gripped state, and it refers to a length of about 10 mm or greater, although this will depend on the size of the hand of the fitting person or the size of the belt-shaped body.

Since the belt-shaped body of aspect 1 comprises a gripping part as described above between one side edge in the lengthwise direction and the first engagement section, when a person (such as an owner) fitting the belt-shaped body onto the torso of the animal fits the belt-shaped body onto the torso of the animal, and after the first engagement section and the second engagement section have been engaged and fastened, the gripping part is gripped and engagement and fastening of the first engagement section and second engagement section is released while the tightening force of the belt-shaped body is adjusted and the fitting position is finely adjusted. After the tightening force has been adjusted and the fitting position has been finely adjusted, the first engagement section and second engagement section may be re-engaged to maintain its state.

Since the belt-shaped body of aspect 1 can thus be fitted onto the torso of the animal by closely fitting the belt-shaped body at the proper position, the lower crotch member anchored to the belt-shaped body can be accurately contacted with the lower crotch of the animal, and excreta such as urine that have been excreted from the animal are less likely to leak from the lower crotch member.

According to another aspect (aspect 2) of the invention, the second engagement section in the belt-shaped body of aspect 1 has a smaller length in the lengthwise direction than a length in the widthwise direction.

Since the second engagement section of the belt-shaped body of aspect 2 has a smaller length in the lengthwise direction than the length in the widthwise direction (i.e., the widthwise direction of the second engagement section corresponds to the lengthwise direction of the belt-shaped body), a constant engagement strength can be ensured for engagement between the first engagement section and second engagement section, while release of adjustment of the tightening force and fine adjustment of the fitting position of the belt-shaped body are facilitated by gripping of the gripping part. Therefore, the belt-shaped body of this aspect can be more easily fitted in a close manner to the torso of the animal.

According to yet another aspect (aspect 3) of the invention, the second engagement section of the belt-shaped body according to aspect 1 or 2 has a plurality of engaging protrusions that protrude from the non-torso-facing surface.

Since the second engagement section of the belt-shaped body of aspect 3, which is disposed on the non-torso-facing surface, has a plurality of engaging protrusions (i.e., the first engagement section that engages with the second engagement section has engaging recesses that receive the engaging protrusions of the second engagement section, but no engaging protrusions), when the belt-shaped body is put on, it is possible to prevent the animal's hair from becoming tangled with the first engagement section disposed on the torso-facing surface of the belt-shaped body, or prevent itchy irritation of the torso of the animal by the engaging protrusions. Thus, the belt-shaped body of aspect 3 is unlikely to cause dissatisfaction to the animal when it is worn, and the closely fitted state of the belt-shaped body at the proper position can be more easily maintained.

Therefore, the belt-shaped body of aspect 3 can more persistently exhibit the function and effect of the belt-shaped body according to the aspects described above.

According to yet another aspect (aspect 4) of the invention, in the belt-shaped body any one of aspects 1 to 3, the gripping part comprises a third engagement section that is able to engage with an engaging section of the non-torso-facing surface side, located further toward an inner side in the lengthwise direction than the second engagement section, on the torso-facing surface.

Since the gripping part of the belt-shaped body of aspect 4 comprises a third engagement section that is able to engage with the engaging section of the non-torso-facing surface side, located further toward the inner side in the lengthwise direction than the second engagement section, on the torso-facing surface, a person fitting the belt-shaped body onto the torso of the animal, after having adjusted the tightening force and finely adjusted the fitting position of the belt-shaped body, can maintain its state by re-engaging the first engagement section and second engagement section, while engaging the third engagement section with the engaging section on the non-torso-facing surface side, thereby allowing the state to be more reliably maintained.

In addition, when the gripping part located further toward the outer side in the lengthwise direction than the first engagement section is engaged and fastened with the engaging section on the non-torso-facing surface side by the third engagement section, this makes it less likely that the one side edge in the lengthwise direction of the belt-shaped body will curl up, or that the one side edge will catch onto the claws of the animal or onto external structures, or that engagement between the first engagement section and second engagement section will be detached, and therefore the belt-shaped body of aspect 4 can more reliably maintain the closely fitted state of the belt-shaped body at the proper position.

Therefore, the belt-shaped body of aspect 4 can more reliably and persistently exhibit the function and effect of the belt-shaped body according to the aspects described above.

According to yet another aspect (aspect 5) of the invention, the third engagement section in the belt-shaped body of aspect 4 has a smaller length in the lengthwise direction than the length in the widthwise direction.

Because a belt-shaped body that has been fitted around the torso of an animal is usually curved in the lengthwise direction, repulsive force tending to cause the curved state to return to its original state is produced due to rigidity at the relatively highly rigid engagement section, and engagement by the engagement section is more easily detached; however, since the belt-shaped body of aspect 5 has the length in the lengthwise direction of the third engagement section smaller than the length in the widthwise direction, the region of the third engagement section that curves in the lengthwise direction can be reduced, while the region that engages with the engaging section on the non-torso-facing surface side can be ensured to be wide in the widthwise direction, making engagement between the third engagement section and the engaging section on the non-torso-facing surface side less likely to become detached.

Therefore, the belt-shaped body of aspect 5 can more reliably exhibit the function and effect of the belt-shaped body of aspect 4.

According to yet another aspect (aspect 6) of the invention, the third engagement section of the belt-shaped body according to aspect 4 or 5 has a plurality of engaging protrusions that protrude from the non-torso-facing surface.

Since the third engagement section of the belt-shaped body of aspect 6 has a plurality of engaging protrusions (i.e., the engaging section on the non-torso-facing surface side that engages with the third engagement section has engaging recesses that receive the engaging protrusions of the third engagement section, and does not have engaging protrusions), it is possible to prevent increased rigidity of the engaging section on the non-torso-facing surface side that engages with the third engagement section, caused by the presence of engaging protrusions. Since it is thereby possible to ensure a wider engaging section on the non-torso-facing surface side, without increasing the rigidity of the belt-shaped body, the belt-shaped body of aspect 6 allows adjustment of the tightening force or fine adjustment of the fitting position of the belt-shaped body to be more easily and more precisely accomplished.

According to yet another aspect (aspect 7) of the invention, in the belt-shaped body of any one of aspects 4 to 6, the engaging section on the non-torso-facing surface side extends from a lengthwise inside edge of the second engagement section in the lengthwise direction, passing beyond a lengthwise center axis running in the widthwise direction of the belt-shaped body.

Since the engaging section on the non-torso-facing surface side of the belt-shaped body of aspect 7 extends across a wide region in the lengthwise direction, the degree of freedom is increased for the location of engagement between the third engagement section and the engaging section on the non-torso-facing surface side, and the fitted state after adjustment of the tightening force and fine adjustment of the fitting position of the belt-shaped body can be more accurately maintained.

### Advantageous Effects of Invention

With the belt-shaped body of the invention, a lower crotch member such as a disposable diaper can be accurately contacted with the lower crotch of an animal, and excreta such as urine that have been excreted from the animal can be made less likely to leak from the lower crotch member.

### BRIEF DESCRIPTION OF DRAWINGS

FIG. 1 is a perspective view of a belt-shaped body 1 according to an embodiment of the invention.

FIG. 2 is a plan view of the belt-shaped body 1, as viewed in the thickness direction from the torso-facing surface side, in the expanded state.

FIG. 3 is a plan view of the belt-shaped body 1, as viewed in the thickness direction from the non-torso-facing surface side, in the expanded state.

FIG. 4 is a lengthwise cross-sectional end view of the belt-shaped body 1, along the widthwise center axis line C_{L} in the widthwise direction of FIG. 2.

FIG. 5 is a plan view of the lower crotch member 10 of an absorbent article for an animal in which the belt-shaped body of the invention can be applied, as viewed from the torso-facing surface side in the thickness direction, in the expanded state.

FIG. 6(a) is a schematic diagram showing the state of engaging the first engagement section and second engagement section of the belt-shaped body 1 to fit the belt-shaped body 1 onto a dog (temporary fitting), FIG. 6(b) is a schematic diagram showing the state in which the owner grips the gripping part of the belt-shaped body 1 for adjustment of the tightening force or fine adjustment of the fitting position of the belt-shaped body 1, and FIG. 6(c) is a schematic diagram showing the state of re-engaging the first engagement section and second engagement section of the belt-shaped body 1 after adjustment of the tightening force or fine adjustment of the fitting position of the belt-shaped body 1, to fit the belt-shaped body 1 onto the dog (main fitting).

FIG. 7 is a schematic diagram showing a belt-shaped body 1 and a lower crotch member 10 in the state fitted on a dog.

### DESCRIPTION OF EMBODIMENTS

Preferred embodiments of the belt-shaped body of the invention will now be explained in greater detail with reference to the accompanying drawings. Throughout the present description, unless otherwise specified, the concept of “viewing an object (for example, a belt-shaped body or lower crotch member) on the horizontal plane in the expanded state in the thickness direction of the object, from the upper side in the vertical direction”, will be referred to simply by the phrase “in the plan view”.

The directions used throughout the present description are as follows, unless otherwise specified.

Throughout the present description, “lengthwise direction” refers to the “long direction of the lengths of a longitudinal object (for example, a belt-shaped body or lower crotch member) in the plan view”, “widthwise direction” refers to the “short direction of the lengths of a longitudinal object in the plan view”, and “thickness direction” refers to the “vertical direction of an object situated on the horizontal plane in the expanded state”, with the lengthwise direction, widthwise direction and thickness direction being in a mutually perpendicular relationship.

Also, throughout the present description, the concept of the “relatively proximal side in the widthwise direction of a longitudinal object (for example, a belt-shaped body) with respect to the widthwise center axis line C_{L} located at the center in the widthwise direction of the object and running in the lengthwise direction” is referred to as the “inner side in the widthwise direction”, and the concept of the “relatively distal side in the widthwise direction of a longitudinal object, with respect to the widthwise center axis line C_{L}” is referred to as the “outer side in the widthwise direction”. Similarly, the concept of the “relatively proximal side in the lengthwise direction of a longitudinal object, with respect to the lengthwise center axis line C_{W} located at the center in the lengthwise direction of the object and running in the widthwise direction” is referred to as the “inner side in the lengthwise direction”, and the concept of the “relatively distal side in the lengthwise direction of a longitudinal object, with respect to the lengthwise center axis line C_{W}” is referred to as the “outer side in the lengthwise direction”.

Also throughout the present description, the “direction in which the torso of an animal wearing the belt-shaped body extends” is referred to as “front-rear direction of the animal”, the “relatively proximal side with respect to the head of the animal in the front-rear direction of the animal” is referred to as the “front side of the animal”, and the “relatively distal side with respect to the head of the animal in the front-rear direction of the animal” is referred to as the “rear side of the animal”.

Moreover, throughout the present description, unless otherwise specified, the “one side that is the relatively proximal side with respect to the torso of an animal in the thickness direction of the belt-shaped body and lower crotch member, when the belt-shaped body and lower crotch member have been fitted onto the torso of the animal”, is referred to as the “torso-facing surface side”, and the “other side that is the relatively distal side with respect to the torso of the animal in the thickness direction of the belt-shaped body and lower crotch member, when the belt-shaped body and lower crotch member have been fitted onto the torso of the animal”, is referred to as the “non-torso-facing surface side”. Incidentally, throughout the present description, the “surface on the torso-facing surface side” and “surface on the non-torso-facing surface side” for the belt-shaped body, the lower crotch member and each of the members composing them (for example, the core member, inner surface member, outer surface member, top sheet, absorbent body and back sheet) may be referred to simply as “torso-facing surface” and “non-torso-facing surface”, respectively.

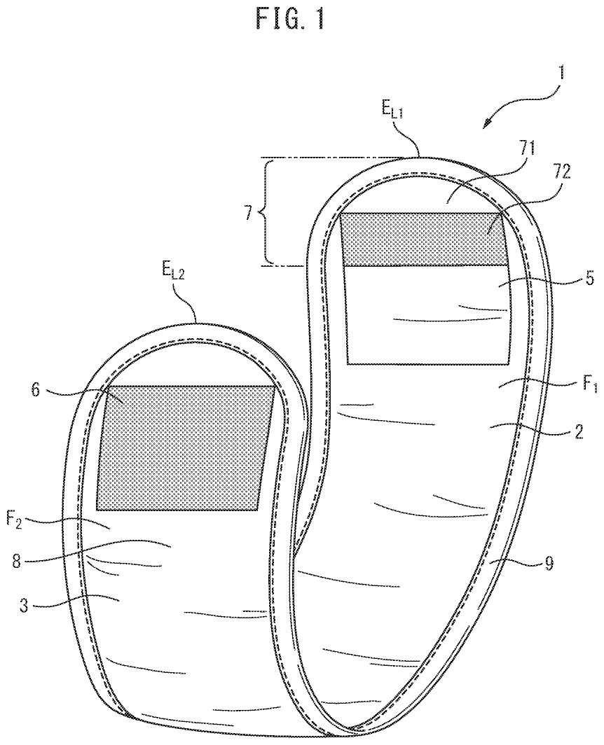

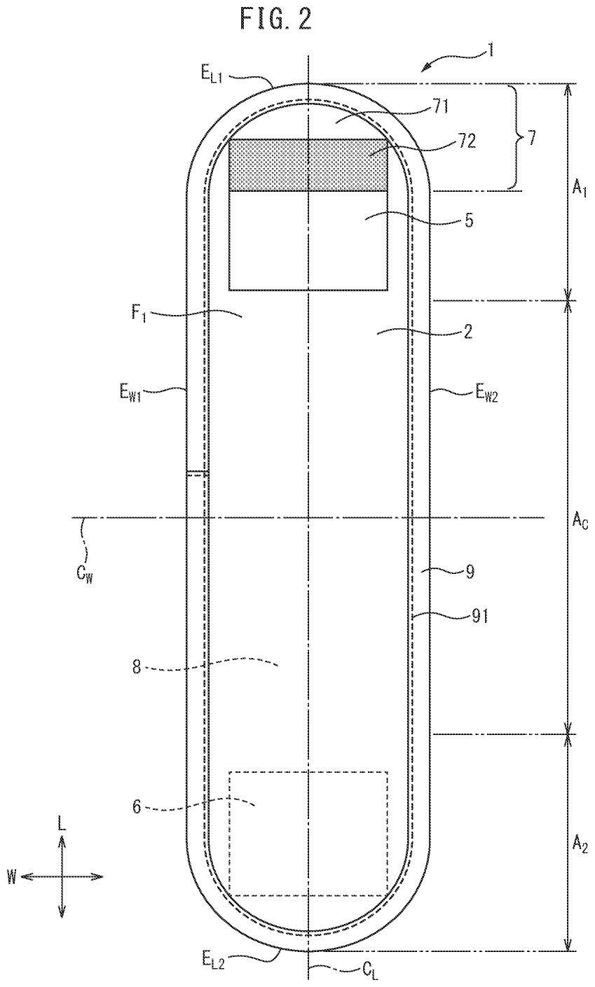

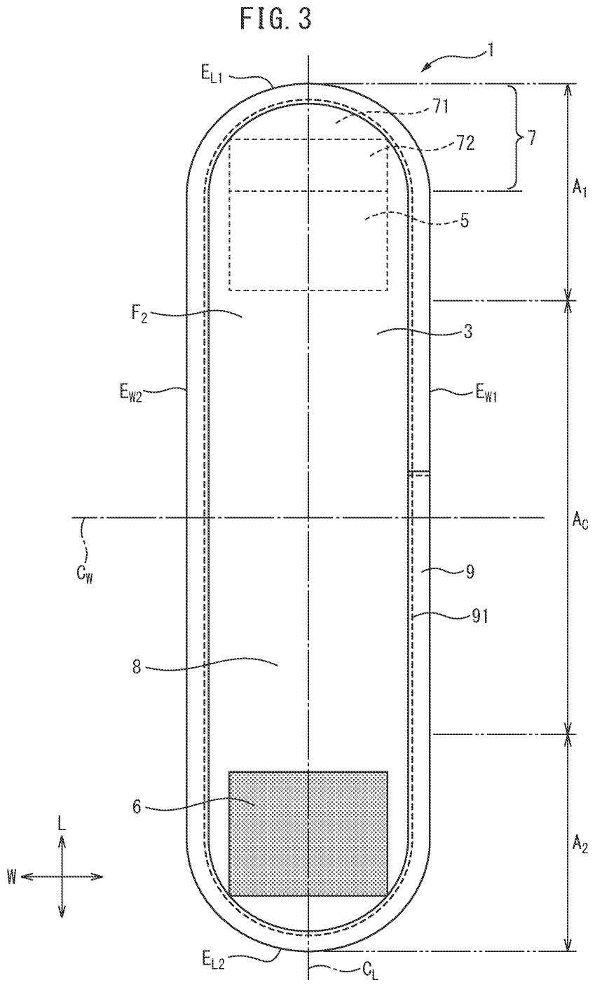

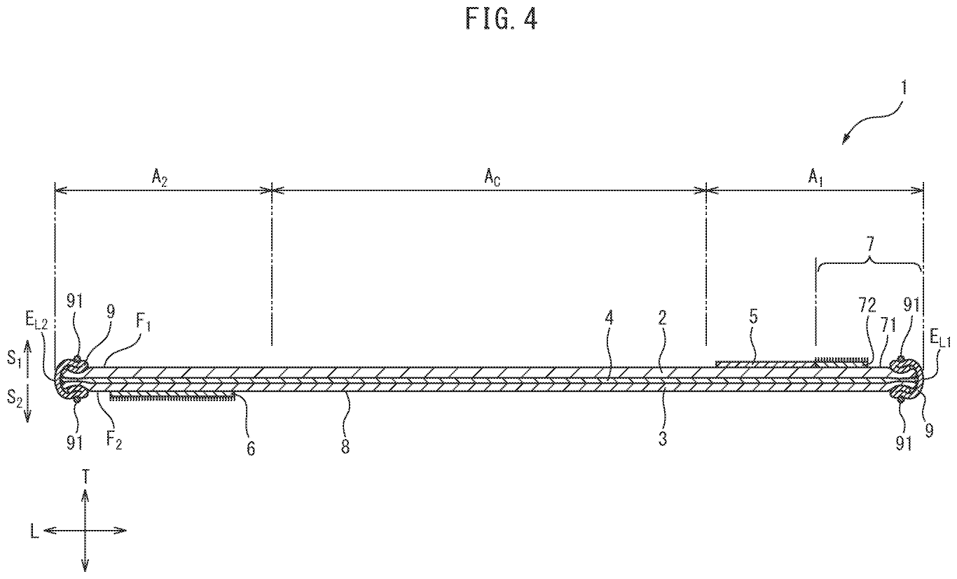

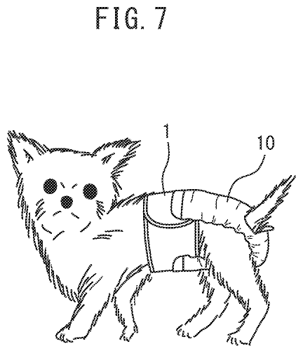

FIG. 1 is a perspective view of the belt-shaped body 1 according to an embodiment of the invention, FIG. 2 is a plan view of the belt-shaped body 1 as viewed from the torso-facing surface side in the thickness direction T, in the expanded state, and FIG. 3 is a plan view of the belt-shaped body 1 as viewed from the non-torso-facing surface side in the thickness direction T, in the expanded state. FIG. 4 is a lengthwise cross-sectional end view of the belt-shaped body 1 along the widthwise center axis line C_{L} of FIG. 2, and FIG. 7 is a schematic diagram showing the state of the belt-shaped body 1 and lower crotch member 10 when fitted onto a dog.

As shown in FIG. 7, the belt-shaped body 1 according to one embodiment of the invention is a reusable belt-shaped member fitted in a freely detachable manner along the periphery of the torso including the abdominal region and dorsal region of an animal such as a dog, while serving to anchor in a freely detachable manner the lower crotch member (for example, a disposable diaper or incontinence pad for an animal) that is disposed in the lower crotch region of the animal (more specifically, disposed at a section from the abdominal region reaching to the dorsal region of the animal, with the lower crotch region of the animal as the center). As shown in FIGS. 1 to 4, the belt-shaped body 1 has a lengthwise direction L corresponding to the direction around the torso of the animal, a widthwise direction W corresponding to the front-rear direction of the animal, and a thickness direction T, and it has, in the plan view, a longitudinal outer shape wherein each of both edges in the lengthwise direction L (in the depiction in FIG. 2 and FIG. 3, one side edge E_{L1} and the other side edge E_{L2} in the lengthwise direction L) protrude in an arc-shaped manner toward the outer side in the lengthwise direction, and both edges in the widthwise direction W (in the depiction in FIG. 2 and FIG. 3, one side edge E_{W1} and the other side edge E_{W2} in the widthwise direction W) extend in a straight linear manner along the lengthwise direction L, being constructed so as to be wrapped around the periphery of the torso of the animal (i.e., so that the length in the lengthwise direction L of the belt-shaped body 1 is greater than the length around the torso of the animal).

According to the invention, the outer shape and outer dimensions of the belt-shaped body are not limited to the aspect of this embodiment, and so long as it is a longitudinal outer shape having a length in the lengthwise direction that is greater than the length around the torso of the animal that is to wear it, any desired longitudinal outer shape (for example, rectangular, rounded-corner rectangular, approximately rectangular with arc-shaped corners, elliptical or hourglass-shaped) and outer dimensions may be employed, depending on the type, body frame and size of the animal.

As shown in FIGS. 1 to 4, the belt-shaped body 1 of this embodiment has a torso-facing surface F₁ that faces the torso of the animal and a non-torso-facing surface F₂ as the surface on the opposite side from the torso-facing surface F₁, when it is worn, and with an anchoring surface on which the lower crotch member 10 is to be anchored in a freely detachable manner, and in the plan view, it has a center region A_{C} located at the center in the lengthwise direction L and corresponding to the abdominal region of the animal when it is worn, a first region A₁ extending between the one side edge E_{L1} and the center region A_{C} in the lengthwise direction L and corresponding to the dorsal region of the animal when it is worn, and a second region A₂ extending between the other side edge E_{L2} and the center region A_{C} in the lengthwise direction L and corresponding to the dorsal region of the animal when it is worn.

The belt-shaped body 1 comprises, as the basic construction in the thickness direction T, an inner surface member 2 situated on the torso-facing surface side of the belt-shaped body 1 to form the torso-facing surface F₁ of the belt-shaped body 1, an outer surface member 3 situated on the non-torso-facing surface side of the belt-shaped body 1 to form the non-torso-facing surface F₂ of the belt-shaped body 1, a core member 4 situated between the surface members to impart a prescribed rigidity to the belt-shaped body 1, a loop member 5 (first engagement section) disposed on the torso-facing surface F₁ of the first region A₁ of the belt-shaped body 1, and a hook member 6 (second engagement section) that is disposed on the non-torso-facing surface F₂ of the second region A₂ of the belt-shaped body 1 and is able to engage with the loop member 5. For this embodiment, in the plan view, the inner surface member 2, outer surface member 3 and core member 4 each extend from one side edge E_{L1} to the other side edge E_{L2} in the lengthwise direction L of the belt-shaped body 1, while also extending from one side edge E_{W1} to the other side edge E_{W2} in the widthwise direction W of the belt-shaped body 1.

Also, as shown in FIGS. 2 to 4, the belt-shaped body 1 comprises a hook member 72 (third engagement section) that is disposed adjacent to the outer side of the loop member 5 in the lengthwise direction , on the torso-facing surface F₁ of the first region A₁ of the belt-shaped body 1, and is able to engage with the engaging section 8 on the non-torso-facing surface side located on the inner side of the hook member 6 in the lengthwise direction on the non-torso-facing surface F₂, and a rigidity reinforcing member 9 that is disposed in a manner extending from the torso-facing surface F₁ to the non-torso-facing surface F₂ of the belt-shaped body 1, at the outer perimeter edge section of the belt-shaped body 1 (i.e., the edge section along the entire outer perimeter of the belt-shaped body 1, consisting of one side edge E_{L1} and the other side edge E_{L2} in the lengthwise direction L and one side edge E_{W1} and the other side edge E_{W2} in the widthwise direction W of the belt-shaped body 1) (in other words, as a trimming), thus allowing the belt-shaped body 1 to be steadily fitted onto the torso of the animal.

Throughout the present description, the first region in the lengthwise direction of the belt-shaped body is a region extending from one side edge in the lengthwise direction of the belt-shaped body (for this embodiment, the one side edge E_{L1} depicted in FIG. 2 and FIG. 3) toward the inner side in the lengthwise direction, in the plan view, the region corresponding to the dorsal region of the animal when the belt-shaped body is put on, and the length in the lengthwise direction being about ¼ of the length in the lengthwise direction of the entire belt-shaped body. Similarly, the second region in the lengthwise direction of the belt-shaped body is a region extending from the other side edge in the lengthwise direction of the belt-shaped body (for this embodiment, the other side edge E_{L2} depicted in FIG. 2 and FIG. 3) toward the inner side in the lengthwise direction, in the plan view, the region corresponding to the dorsal region of the animal when the belt-shaped body is put on, and the length in the lengthwise direction being about ¼ of the length in the lengthwise direction of the entire belt-shaped body. Also, the center region in the lengthwise direction of the belt-shaped body is the region extending between the first region and second region, the region corresponding to the abdominal region of the animal when the belt-shaped body is put on, and the length in the lengthwise direction being about ½ of the length in the lengthwise direction of the entire belt-shaped body. The lengths in the lengthwise direction of the first region, second region and center region are appropriately set depending on the type, body frame and size of the animal on which the belt-shaped body is to be fitted.

The anchoring surface is the surface on the non-torso-facing surface of the belt-shaped body where the lower crotch member is to be anchored in a freely detachable manner (the surface where the abdominal region side engaging member 17 and dorsal region side engaging member 18, which are disposed on the first surface F₃ as the torso-facing surface of the lower crotch member 10 described below, are to be engaged and fastened in a freely detachable manner). For this embodiment, on the non-torso-facing surface F₂ of the belt-shaped body 1, all of the surface other than the surface on which the hook member 6 (second engagement section) and rigidity reinforcing member 9 are disposed may function as an anchoring surface; however, the anchoring surface may also be formed so that only prescribed portion on the non-torso-facing surface F₂ of the belt-shaped body can function as the anchoring surface.

For this embodiment, the belt-shaped body 1 comprises a gripping part 7 with a length in the lengthwise direction such as to allow gripping, between one side edge E_{L1} in the lengthwise direction L and the loop member 5 (first engagement section) disposed on the torso-facing surface F₁ of the first region A₁ and which does not engage with the hook member 6 (second engagement section) disposed on the non-torso-facing surface F₂ of the second region A₂. Incidentally, as shown in FIGS. 2 to 4, the gripping part 7 of this embodiment includes a hook member 72 (third engagement section) disposed adjacent to the outer side of the loop member 5 in the lengthwise direction, on the torso-facing surface F₁ of the first region A₁ of the belt-shaped body 1, and a non-engagement section 71 adjacent to the outer side of the hook member 72 in the lengthwise direction, that does not engage with the hook member 6 (second engagement section).

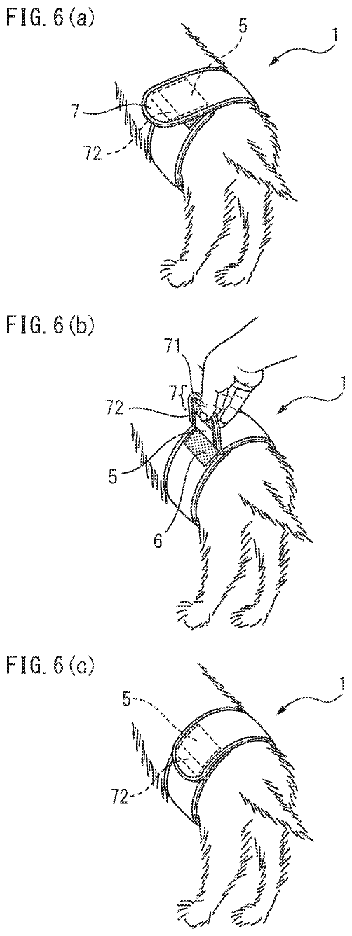

Since the belt-shaped body 1 of this embodiment comprises a gripping part 7 as described above between one side edge E_{L1} in the lengthwise direction L and the loop member 5 (first engagement section), when an owner fits the belt-shaped body 1 onto the torso of an animal such as a dog, and after the loop member 5 (first engagement section) and hook member 6 (second engagement section) have been engaged and fastened (see FIG. 6(a)), the gripping part 7 is gripped and engagement and fastening of the loop member 5 (first engagement section) and hook member 6 (second engagement section) is released while the tightening force of the belt-shaped body 1 is adjusted and the fitting position of the belt-shaped body 1 is finely adjusted (see FIG. 6(b)). Incidentally, after adjusting the tightening force or fine adjustment of the fitting position of the belt-shaped body 1, the loop member 5 (first engagement section) and hook member 6 (second engagement section) may be re-engaged to maintain the state.

Since the belt-shaped body 1 of this embodiment can thus be fitted onto the torso of the animal by close fitting at the proper position, the lower crotch member 10 anchored to the belt-shaped body 1 can be accurately contacted with the lower crotch of the animal, and the excreta such as urine that have been excreted from the animal are less likely to leak from the lower crotch member 10.

The belt-shaped body 1 of this embodiment is fitted onto the torso of the animal in the following manner.

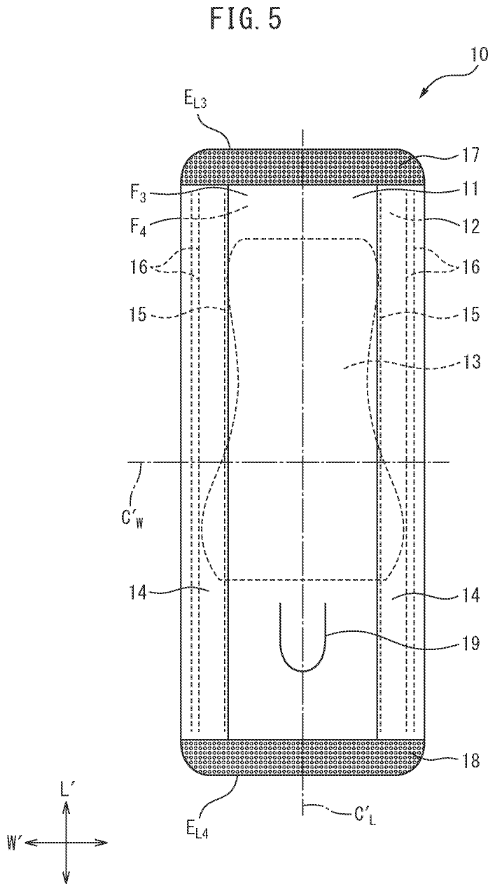

FIG. 5 is a plan view of the lower crotch member 10 of an absorbent article for an animal in which the belt-shaped body of the invention can be applied, as viewed from the torso-facing surface side in the thickness direction, in the expanded state, FIG. 6(a) is a schematic diagram showing the state of engaging the first engagement section and second engagement section of the belt-shaped body 1 to fit the belt-shaped body 1 onto a dog (animal) (temporary fitting), FIG. 6(b) is a schematic diagram showing the state in which the owner grips the gripping part of the belt-shaped body 1 for adjustment of the tightening force or fine adjustment of the fitting position of the belt-shaped body 1, and FIG. 6(c) is a schematic diagram showing the state of re-engaging the first engagement section and second engagement section of the belt-shaped body 1 after adjustment of the tightening force or fine adjustment of the fitting position of the belt-shaped body 1, to fit the belt-shaped body 1 onto the dog (main fitting).

First, the belt-shaped body 1 is set on the torso of the animal so that the lengthwise direction L matches the direction around the torso of the animal and the center region A_{C} faces the abdominal region of the animal, and is then wrapped around the torso of the animal along the periphery of the torso of the animal. During this time, on the dorsal region of the animal, the first region A₁ on one side in the lengthwise direction L of the belt-shaped body 1 overlaps onto the second region A₂ on the other side (specifically, onto the non-torso-facing surface of the second region A₂), and as shown in FIG. 6(a), the loop member 5 (first engagement section) disposed on the torso-facing surface F₁ of the first region A₁ is engaged and fastened with the hook member 6 (second engagement section) disposed on the non-torso-facing surface F₂ of the second region A₂. The belt-shaped body 1 is thus temporarily fitted on the torso of the animal.

After the temporary fitting, as shown in FIG. 6(b), the gripping part 7 located between one side edge E_{L1} in the lengthwise direction L of the belt-shaped body 1 and the loop member 5 (first engagement section) is gripped, to release the engaged fastening between the loop member 5 (first engagement section) and hook member 6 (second engagement section), while adjustment of the tightening force or fine adjustment of the fitting position of the belt-shaped body 1 is made and the state is maintained while re-engaging the loop member 5 (first engagement section) and hook member 6 (second engagement section), for main fitting of the belt-shaped body 1 onto the torso of the animal.

Moreover, for this embodiment, the hook member 72 (third engagement section) disposed on the torso-facing surface F₁ of the belt-shaped body 1 is engaged and fastened with the engaging section 8 on the non-torso-facing surface side located further toward the inner side in the lengthwise direction than the hook member 6, on the non-torso-facing surface F₂ of the belt-shaped body 1 as shown in FIG. 6(c), and therefore the gripping part 7 is also anchored along the periphery of the torso of the animal.

With the belt-shaped body 1 thus fitted onto the torso of the animal, as further shown in FIG. 7, the lower crotch member 10 comprising the absorbent body 13 is then engaged and fastened onto the anchoring surfaces of the respective non-torso-facing surfaces F₂ in the center region A_{C} and first region A₁ of the belt-shaped body 1.

The “animal” to which the belt-shaped body of the invention is to be applied is not particularly restricted so long as it is an animal that can be reared, such as a pet, and it may be an animal such as a dog, as exemplified by this embodiment, or a cat or monkey. Incidentally, the “excreta” to be absorbed and held by the absorbent article for an animal to which the belt-shaped body of the invention is applied (for example, a disposable diaper or incontinence pad) are not particularly restricted, and for example, they may be various types of excreta such as urine or feces, or blood.

Each of the members forming the belt-shaped body of the invention will now be explained in detail using the belt-shaped body 1 according to the embodiment described above.

### [Inner Surface Member]

As shown in FIG. 2 and FIG. 4, the inner surface member 2 of the belt-shaped body 1 of this embodiment is composed of a flexible sheet member that has, in the plan view, a longitudinal outer shape that extends from one side edge E_{L1} to the other side edge E_{L2} in the lengthwise direction L of the belt-shaped body 1 while extending from one side edge E_{W1} to the other side edge E_{W2} in the widthwise direction W (more specifically, a longitudinal outer shape wherein each of both edges in the lengthwise direction L protrudes in an arc-shaped manner toward the outer side in the lengthwise direction), and is disposed at a location on the torso-facing surface side in the thickness direction T of the belt-shaped body 1, so as to be able to directly contact the torso of the animal on which it is worn. Incidentally for this embodiment, the inner surface member 2 is formed of a non-engaging flexible sheet member that does not engage with any of the hook members used in the engagement sections of the belt-shaped body 1, and therefore the non-engagement section 71 is formed as part of the torso-facing surface F₁ of the inner surface member 2.

According to the invention, the flexible sheet member that may be used as the inner surface member is not particularly restricted so long as it has prescribed flexibility allowing it to be used as an inner surface member for the belt-shaped body and is reusable by washing or the like, and any of various sheet members may be employed including nonwoven fabrics such as felt or fleece; woven fabrics; knitted fabrics such as a mesh members; natural leather; synthetic leather; or resin sheets such as polyolefin or polyester sheets; however, from the viewpoint of flexibility, air permeability, feel on the skin, ease of care (easy washability) and strength, it is preferred to use a fiber sheet such as a nonwoven fabric, woven fabric or knitted fabric. When the flexible sheet member is such a fiber sheet, the constituent fibers are not particularly restricted, and any fibers such as synthetic fibers (such as polyester fiber or nylon fiber), natural fibers (such as cotton or silk), regenerated fibers (such as rayon or cupra) or semisynthetic fibers (such as acetate fibers) may be used, such fibers being used alone, or any two or more different types of fibers being used in combination.

Also, the structure of the flexible sheet member that may be used as the inner surface member is not particularly restricted, and it may be a flat, nonporous sheet member, or it may be a perforated sheet member or a sheet member having a protrusion-recess structure (for example, a protrusion-recess structure with an undulating cross-sectional shape). The flexible sheet member may be either a sheet member with a monolayer structure or a sheet member with a multilayer structure.

The dimensional shape and thickness of the flexible sheet member that may be used as the inner surface member for the invention is not particularly restricted so long as the flexible sheet member can function as an inner surface member for a belt-shaped body, and any desired dimensional shape and thickness may be employed depending on the desired flexibility, air permeability, feel on the skin and strength.

### [Core Member]

The core member 4 in the belt-shaped body 1 of this embodiment is composed of a rigid sheet member that has, in the plan view, the same longitudinal outer shape as the inner surface member 2, that extends from one side edge E_{L1} across to the other side edge E_{L2} in the lengthwise direction L of the belt-shaped body 1 while extending from one side edge E_{W1} across to the other side edge E_{W2} in the widthwise direction W, and is disposed at a location further toward the non-torso-facing surface side than the inner surface member 2 in the thickness direction T of the belt-shaped body 1 (more specifically, a location between the inner surface member 2 and the outer surface member 3), being able to impart a prescribed rigidity or strength to the belt-shaped body 1.

According to the invention, the rigid sheet member that may be used as the core member is not particularly restricted so long as it has prescribed rigidity allowing it to be used as a core member for the belt-shaped body and is reusable by washing or the like, and any of various sheet members may be employed including woven fabrics such as plain weave fabrics; nonwoven fabrics; knitted fabrics; natural leather; synthetic leather; and resin sheets such as polyolefin or polyester sheets, although from the viewpoint of rigidity, consistent flexibility, air permeability and strength, it is preferred to use a fiber sheet such as a nonwoven fabric, woven fabric or knitted fabric. When the rigid sheet member is made of a fiber sheet such as a woven fabric, the constituent fibers are not particularly restricted and may be the same as in the flexible sheet member described above.

The rigidity value of the rigid sheet member to be used as the core member is also not particularly restricted, but from the viewpoint of ease of wrapping of the belt-shaped body and following property for the shape of the torso, it is preferably in the range of 0.5×10⁻⁴ to 12×10⁻⁴ N·m²/m. The rigidity value of a rigid sheet member can be obtained by a flexural rigidity test, i.e by cutting a test piece of a prescribed size (for example, 100 mm×100 mm) from the sheet member to be measured and then measuring the flexural rigidity in each direction of the test piece (i.e., the directions corresponding to the lengthwise direction and widthwise direction of the member being measured) using a KES FB-2 Pure Bending Tester (product of Kato Tech Corp.).

The dimensional shape and thickness of the rigid sheet member that may be used as the core member for the invention is not particularly restricted so long as the rigid sheet member can function as a core member for a belt-shaped body, and any desired dimensional shape and thickness may be employed depending on the desired rigidity, flexibility and air permeability.

Incidentally, if the belt-shaped body has the rigidity for the belt-shaped body as a whole that is prescribed according to the invention, due to structural members other than the core member (for example, the inner surface member or outer surface member, the engaging members and the rigidity reinforcing member), the belt-shaped body does not necessarily need to comprise such a core member.

### [Outer Surface Member]

As shown in FIG. 3 and FIG. 4, the outer surface member 3 of the belt-shaped body 1 of this embodiment is composed of an engaging sheet member that has, in the plan view, the same longitudinal outer shape as the inner surface member 2 that extends from one side edge E_{L1} across to the other side edge E_{L2} in the lengthwise direction L of the belt-shaped body 1 while extending from one side edge E_{W1} across to the other side edge E_{W2} in the widthwise direction W, and that is disposed at a location on the non-torso-facing surface side (specifically, a location further toward the non-torso-facing surface side than the core member 4) in the thickness direction T of the belt-shaped body 1, and is able to engage with the abdominal region side engaging member 17 and dorsal region side engaging member 18 disposed on the first surface F₃ as the torso-facing surface of the lower crotch member 10, and the hook member 72 (third engagement section) disposed on the torso-facing surface F₁ of the first region A₁ of the belt-shaped body 1. For this embodiment, therefore, the engaging section 8 on the non-torso-facing surface side, which is located further toward the inner side in the lengthwise direction than the hook member 6 (second engagement section) on the non-torso-facing surface F₂ of the second region A₂ of the belt-shaped body 1, is constructed as part of the non-torso-facing surface F₂ of the outer surface member 3.

According to the invention, the engaging sheet member that may be used as the outer surface member has a prescribed engaging structure (for example, a loop structure or a fiber aggregate structure having prescribed fiber lengths and interfiber distances) which allows different engaging members (for example, the abdominal region side engaging member or dorsal region side engaging member of the lower crotch member, and the hook member forming the third engagement section of the belt-shaped body) to engage with the surface that serves as the non-torso-facing surface of the belt-shaped body, and it is not particularly restricted so long as it has prescribed flexibility and strength allowing it to be used as an outer surface member for the belt-shaped body, and is reusable by washing or the like: for example, it may be a sheet-like loop member composed of a knitted fabric having a base and a plurality of loop sections integrally formed by synthetic fibers; a sheet-like loop member comprising a molded article having a base section and a plurality of loop sections integrally formed by a synthetic resin such as polyester;

or a sheet member such as a nonwoven fabric; however, from the viewpoint of easier engagement with different engaging members, as well as engaging strength and flexibility, it is preferred to use a sheet-like loop member having a base and a plurality of loop sections. In the embodiment described above, the outer surface member 3 is composed of a sheet-like loop member having a base and a plurality of loop sections.

When the engaging sheet member that can be used as the outer surface member of the belt-shaped body is composed of a sheet-like loop member comprising such a molded article, the constituent material is not particularly restricted and may be, for example, a synthetic resin such as a polyester or polyolefin, either as a single type of synthetic resin, or two or more of such resins in combination. Even when the engaging sheet member is made of a sheet-like loop member comprising the aforementioned knitted fabric, or of a nonwoven fabric, the constituent fibers are not particularly restricted and may be the same as in the flexible sheet member described above.

The engaging sheet member that may be used as the outer surface member does not need to have the engaging structure described above for the entirety of the engaging sheet member, it being sufficient if the engaging structure is in the engaging member of the lower crotch member (i.e., the abdominal region side engaging member and dorsal region side engaging member), or at a section of the belt-shaped body capable of engaging with the third engagement section.

Therefore, the engaging sheet member may have the sections other than the section with the engaging structure formed of any arbitrary sheet member (for example, the same type of fiber sheet as the inner surface member).

Incidentally, when the engaging sheet member has an engaging structure at a location allowing it to engage with the engaging member of the lower crotch member, the section with the engaging structure becomes the anchoring surface of the outer surface member (i.e., the anchoring surface on the non-torso-facing surface of the belt-shaped body), and when it has an engaging structure at a location allowing it to engage with the third engagement section, the section with the engaging structure becomes the engaging section on the non-torso-facing surface side.

Moreover, according to the invention, since the anchoring part of the lower crotch member (i.e., the section for freely detachable anchoring to the belt-shaped body) does not need to be the aforementioned engaging members (abdominal region side engaging member and dorsal region side engaging member), when the anchoring part of the lower crotch member is constructed of a member other than an engaging member (for example, a pressure-sensitive adhesive section such as adhesive tape), the outer surface member does not necessarily have to be an engaging sheet member, and any desired sheet member (for example, the same flexible sheet member as the inner surface member) may be employed.

Also, in the belt-shaped body 1 of this embodiment, the engaging section 8 on the non-torso-facing surface side, which is located further toward the inner side in the lengthwise direction than the hook member 6 (second engagement section) on the non-torso-facing surface F₂ of the belt-shaped body 1, extends in the lengthwise direction L of the belt-shaped body 1, passing from the lengthwise inside edge of the hook member 6 (second engagement section) across the lengthwise center axis C_{W} that runs in the widthwise direction W of the belt-shaped body 1. If the engaging section 8 on the non-torso-facing surface side thus extends across a wide region in the lengthwise direction L, the degree of freedom is increased for the location of engagement between the hook member 72 (third engagement section) and the engaging section 8 on the non-torso-facing surface side, and therefore the fitted state after adjustment of the tightening force or fine adjustment of the fitting position of the belt-shaped body 1 (i.e. the main fitting state) can be more accurately maintained.

Incidentally, the dimensional shape and thickness of the engaging sheet member that may be used as the outer surface member for the invention is not particularly restricted so long as the engaging sheet member can function as an outer surface member for a belt-shaped body, and any desired dimensional shape and thickness may be employed depending on the desired rigidity, flexibility and air permeability.

### [Engaging Members]

Each of the engaging members (hook member and loop member) to be used in the belt-shaped body of the invention will now be explained in detail using the belt-shaped body 1 according to the embodiment described above. As used herein, “engagement” means a state in which elements with a prescribed structure are connected by mechanically interlocking and the connected state is maintained unless the elements are pulled with a prescribed force, and a typical example of an “engaging member” is a “hook-and-loop fastener”.

### <First Engagement Section>

As shown in FIG. 2 and FIG. 3, the belt-shaped body 1 of this embodiment comprises, as anchoring means for maintaining the fitted state of the belt-shaped body 1 on the torso of the animal, a loop member 5 (first engagement section) disposed on the torso-facing surface F₁ of the first region A₁ of the belt-shaped body 1, and a hook member 6 (second engagement section) that is disposed on the non-torso-facing surface F₂ of the second region A₂ of the belt-shaped body 1 and is able to engage with the loop member 5. For this embodiment, the loop member 5 (first engagement section) has an essentially rectangular outer shape having a prescribed length in the lengthwise direction (length in the direction along the lengthwise direction L of the belt-shaped body 1) and length in the widthwise direction (length in the direction along the widthwise direction W of the belt-shaped body 1).

According to the invention, the loop member that may form the first engagement section is not particularly restricted so long as it is able to engage with the hook member of the second engagement section, and for example, a sheet-like loop member similar to the outer surface member described above may be used.

The first engagement section used for the invention is not limited to a loop member, and may be a hook member instead. In this case, the second engagement section is formed by the loop member. However, the first engagement section is preferably formed of loop member as in this embodiment. If the first engagement section disposed on the torso-facing surface of the belt-shaped body is formed by such loop member, then the loop member will have engaging recesses (i.e. loop sections) that receive the engaging protrusions of the second engagement section, while lacking engaging protrusions, and therefore when the belt-shaped body is put on, it will be possible to prevent the animal's hair from becoming tangled with the first engagement section disposed on the torso-facing surface of the belt-shaped body, or prevent itchy irritation of the torso of the animal by the engaging protrusions. Thus, the belt-shaped body is unlikely to cause dissatisfaction to the animal when it is worn, and the closely fitted state of the belt-shaped body at the proper position of the animal can be more easily maintained.

The dimensional shape and thickness of the first engagement section for the invention is not particularly restricted so long as it can engage with the second engagement section, and any dimensional shape and thickness may be employed depending on the desired engaging strength, rigidity and flexibility.

### <Second Engagement Section>

In the belt-shaped body 1 of this embodiment, the hook member 6 (second engagement section) that is disposed on the non-torso-facing surface F₂ of the second region A₂ of the belt-shaped body 1 has an essentially rectangular outer shape that extends long in the widthwise direction W of the belt-shaped body 1. As shown in FIG. 4, the hook member 6 (second engagement section) of this embodiment has a base disposed on the non-torso-facing surface F₂ of the outer surface member 3 and a plurality of engaging protrusions protruding from the base to the non-torso-facing surface side, with each of the plurality of engaging protrusions having a shaft portion running from the base toward the non-torso-facing surface side, and at the end of the shaft portion (specifically, the end of the shaft portion located at the opposite side from the base), a widening portion expanding in the direction in which the outer peripheral surface of the shaft portion widens, or in other words, it is composed of a mushroom-type hook member. For this embodiment, the hook member 72 (third engagement section) disposed on the torso-facing surface F₁ of the first region A₁ of the belt-shaped body 1 is also composed of a hook member having the same structure as the hook member 6 (second engagement section).

According to the invention, the hook member that may form the second engagement section is not limited to a hook member having the structure specified above (i.e., a mushroom-type hook member), and for example, it is suitable to use a hook member having any of various structures, including a structure in which the tips of the shaft portions are folded toward the base, also known as a key-type hook member. However, if a hook member having the specified structure is used as a hook member for the second engagement section, and if the hook member is engaged and fastened to the loop member (first engagement section) disposed on the torso-facing surface of the belt-shaped body, then it is possible to maintain the engaged state of the hook member (second engagement section) on the loop member in response to various directions of force, even when the engaged and fastened portion gets pulled in different directions by movement of the animal, and therefore the engaged state of the hook member (second engagement section) and the loop member (first engagement section) can be more firmly maintained, and as a result, the belt-shaped body is less likely to shift from the proper position on the torso of the animal and less likely to slip off from the torso of the animal. In addition, since the hook member having such a specific structure can engage with any fiber structure even if it is not a loop member with a specific engaging structure (for example, a nonwoven fabric or knitted fabric), there is no need to form the first engagement section of a prescribed loop member, thereby allowing various product designs to be realized for different types of product concepts designed for resource savings or cost reduction.

The constituent materials of the hook member that can form the second engagement section are not particularly restricted, and any desired synthetic resins such as polyesters or polyolefins, polyamides, polyvinyl chloride, olefin-based elastomers or urethane-based elastomers, for example, may be used, such synthetic resins being single types of resins or combinations of two or more different resins.

For this embodiment, the hook member 6 (second engagement section) is formed with a smaller length in the lengthwise direction L than the length in the widthwise direction W. If the length of the second engagement section in the lengthwise direction L is thus smaller than the length in the widthwise direction W, then since the widthwise direction of the second engagement section corresponds to the lengthwise direction L of the belt-shaped body 1, a constant engagement strength can be ensured for engagement between the first engagement section and second engagement section, while release of adjustment of the tightening force or fine adjustment of the fitting position of the belt-shaped body 1 are facilitated by gripping of the gripping part 7. Therefore, the belt-shaped body 1 of this aspect can be more easily fitted in a close manner to the torso of the animal.

The second engagement section used for the invention is not limited to a hook member, and may be a loop member instead. In this case, the first engagement section is formed by the hook member. However, the second engagement section is preferably formed by a hook member having a plurality of engaging protrusions, as in the embodiment described above. If the second engagement section disposed on the non-torso-facing surface of the belt-shaped body is formed by such a hook member having a plurality of engaging protrusions, the first engagement section that engages with the hook member will be formed by a loop member that has engaging recesses (i.e. loop sections) that receive the engaging protrusions of the hook member, while lacking engaging protrusions, and therefore when the belt-shaped body is put on, it will be possible to prevent the animal's hair from becoming tangled with the first engagement section disposed on the torso-facing surface of the belt-shaped body, or prevent itchy irritation of the torso of the animal by the engaging protrusions. Thus, the belt-shaped body is unlikely to cause dissatisfaction to the animal when it is worn, and the closely fitted state of the belt-shaped body at the proper position of the animal can be more easily maintained.

Also, if the belt-shaped body comprises the first engagement section and second engagement section, then when the belt-shaped body is fitted around the torso of an animal, the first engagement section and second engagement section can be engaged and fastened on the dorsal region of the animal while the first region on one side in the lengthwise direction of the belt-shaped body is overlapping with the second region on the other side (i.e., with the non-torso-facing surface of the second region), and therefore a belt-shaped body comprising such a first engagement section and second engagement section has the first region and second region overlapping through the engagement sections when the belt-shaped body is put on, the overlapping portions being formed so as to extend in the widthwise direction of the belt-shaped body. Thus, in the region of the belt-shaped body corresponding to the dorsal region of the animal, rigidity is increased in the direction corresponding to the front-rear direction of the animal (i.e., the widthwise direction of the belt-shaped body), and therefore even with movement of the animal wearing the belt-shaped body, so that it bends around the abdominal region, the belt-shaped body is unlikely to bend in the widthwise direction, and as a result, the center region of the belt-shaped body is less likely to deform in the direction corresponding to the front-rear direction of the animal and the lower crotch member anchored to the belt-shaped body can persistently and accurately contact the lower crotch of the animal.

Incidentally, the dimensional shape and thickness of the second engagement section for the invention is not particularly restricted so long as it can engage with the first engagement section, and any dimensional shape and thickness may be employed depending on the desired engaging strength, rigidity and flexibility.

### <Third Engagement Section>

In the belt-shaped body 1 of the embodiment described above, the hook member 72 (third engagement section), which is disposed adjacent to the outer side of the loop member 5 (first engagement section) in the lengthwise direction, on the torso-facing surface F₁ of the first region A₁ of the belt-shaped body 1, has an essentially rectangular outer shape that extends long in the widthwise direction W of the belt-shaped body 1, and together with the non-engagement section 71 that is adjacent to the outer side of the hook member 72 in the lengthwise direction, it forms a portion of the gripping part 7.

Incidentally, while providing the gripping part with such a third engagement section in the belt-shaped body of the invention is not an essential constituent feature for the invention, the gripping part preferably comprises a third engagement section that is able to engage with the engaging section on the non-torso-facing surface side located further toward the inner side in the lengthwise direction than the second engagement section, on the torso-facing surface of the belt-shaped body. If the gripping part of the belt-shaped body comprises such a third engagement section on the torso-facing surface, then an owner, after having adjusted the tightening force and finely adjusted the fitting position of the belt-shaped body, can maintain its state by re-engaging the first engagement section and second engagement section, while also engaging the third engagement section with the engaging section on the non-torso-facing surface side, thereby allowing the state to be more reliably maintained. In addition, when the gripping part located further toward the outer side in the lengthwise direction than the first engagement section is engaged and fastened with the engaging section on the non-torso-facing surface side by the third engagement section, this makes it less likely that the one side edge in the lengthwise direction of the belt-shaped body will curl up, or that the one side edge will catch onto the claws of the animal or onto external structures, or that engagement between the first engagement section and second engagement section will be detached, and therefore the belt-shaped body can more reliably kept in a closely fitted state at the proper position of the animal.

According to the invention, the hook member that can form the third engagement section is not particularly restricted so long as it can engage with the engaging section on the non-torso-facing surface side, and for example, the same type of hook member may be used as for the second engagement section.

Incidentally, if the third engagement section is formed by a hook member having a plurality of engaging protrusions that protrude toward the torso-facing surface side, similar to the hook member of the second engagement section, then the engaging section on the non-torso-facing surface side that engages with the hook member will be formed by a complementary engaging member having engaging recesses that can receive the engaging protrusions of the hook member while lacking engaging protrusions (a loop member, for example), thus helping to prevent the rigidity of the engaging section on the non-torso-facing surface side from increasing by the presence of engaging protrusions. Since this allows the engaging section on the non-torso-facing surface side to be ensured to have a large area without increasing the rigidity of the belt-shaped body, adjustment of the tightening force or fine adjustment of the fitting position of the belt-shaped body can be more easily and precisely accomplished.

For this embodiment, the hook member 72 (third engagement section) is formed with a smaller length in the lengthwise direction L than the length in the widthwise direction W.

Because a belt-shaped body that has been fitted around the torso of an animal is usually curved in the lengthwise direction, repulsive force tending to cause the curved state to return to its original state is produced due to rigidity at the relatively highly rigid engagement section, so that engagement by the engagement section is more easily detached; however, with a manner of formation in which the length of the hook member 72 (third engagement section) in the lengthwise direction L is smaller than the length in the widthwise direction W, as in the embodiment described above, the region of the hook member 72 (third engagement section) that curves in the lengthwise direction L can be reduced, while the region that engages with the engaging section 8 on the non-torso-facing surface side can be ensured to be wide in the widthwise direction W, making engagement between the hook member 72 (third engagement section) and the engaging section 8 on the non-torso-facing surface side less likely to become detached.

Incidentally, the dimensional shape and thickness of the third engagement section for the invention is not particularly restricted so long as it can engage with the engaging section on the non-torso-facing surface side, and any dimensional shape and thickness may be employed depending on the desired engaging strength, rigidity and flexibility.

### [Rigidity Reinforcing Member]

In the belt-shaped body 1 of the embodiment described above, the rigidity reinforcing member 9 consisted of one belt-shaped member, and as shown in FIGS. 1 to 4, it is disposed at the outer perimeter edge section of the belt-shaped body 1, extending from the torso-facing surface F₁ of the belt-shaped body 1 (specifically, the torso-facing surface of the inner surface member 2) to the non-torso-facing surface F₂ (specifically the non-torso-facing surface of the outer surface member 3).

While providing the belt-shaped body with such a rigidity reinforcing member is not an essential constituent feature for the invention, the belt-shaped body preferably has the rigidity reinforcing member extending in at least the lengthwise direction. If the belt-shaped body has a rigidity reinforcing member extending in the lengthwise direction, then even when force is applied in the widthwise direction of the belt-shaped body (i.e., the direction corresponding to the front-rear direction of the animal) due to activity of the animal when the belt-shaped body is put on, it will be able to resist the force due to the rigidity reinforcing member extending in the direction intersecting with that direction (i.e., the lengthwise direction of the belt-shaped body), so that the belt-shaped body will be less likely to deform in the widthwise direction and the lower crotch member anchored to the belt-shaped body will be even more reliably rendered unlikely to detach.

As shown in FIGS. 2 to 4, the rigidity reinforcing member 9 of this embodiment is joined to the torso-facing surface of the inner surface member 2 and to the non-torso-facing surface of the outer surface member 3 by stitching, at the outer perimeter edge section of the belt-shaped body 1. Specifically, the rigidity reinforcing member 9 is disposed in a manner sandwiching a laminate of the inner surface member 2, the core member 4 and the outer surface member 3, from both the torso-facing surface side and the non-torso-facing surface side, and the rigidity reinforcing member 9, inner surface member 2, core member 4 and outer surface member 3 on the torso-facing surface side and the rigidity reinforcing member 9 on the non-torso-facing surface side are integrally joined by stitching in the thickness direction T by stitching thread 91. Incidentally, the means for joining the rigidity reinforcing member to the torso-facing surface and non-torso-facing surface is not particularly restricted, and instead of stitching means, it may be any other joining means including compression means such as embossing, bonding means using a hot-melt adhesive, or heat fusion means using ultrasonic waves or the like.

The belt-shaped member that may be used as the rigidity reinforcing member is not particularly restricted so long as it is a belt-shaped member having constant rigidity (strength), and a belt-shaped member made of a woven fabric, nonwoven fabric, resin film or laminated sheet of two or more of these in combination, for example, may be used. The belt-shaped member preferably has stretchability in the lengthwise direction, from the viewpoint of facilitating fitting of the belt-shaped body onto the torso of the animal. Examples of belt-shaped members having stretchability in the lengthwise direction include bias tape with interwoven urethane fiber, woven fabrics with interwoven elastic members such as polyurethane fiber or rubber, stretchable nonwoven fabrics containing elastic members, and net-like fabrics formed by weaving synthetic fibers or natural fibers. The rigidity reinforcing member 9 used in the belt-shaped body 1 of this embodiment is bias tape having stretchability in the lengthwise direction.

The dimensional shape and thickness of the belt-shaped member to be used as the rigidity reinforcing member are not particularly restricted so long as it can function as the rigidity reinforcing member, and any dimensional shape and thickness may be employed depending on the desired rigidity and flexibility.

The method of producing the belt-shaped body of the invention using each of the aforementioned members is not particularly restricted, and for example, the belt-shaped body may be produced by laminating the inner surface member and outer surface member, and the engaging members, optionally using joining means (for example, bonding means or stitching means), to obtain a laminate, and then if necessary joining the rigidity reinforcing member to the outer perimeter edge section of the laminate using any desired joining means.

The lower crotch member of an absorbent article for an animal to which the belt-shaped body of the invention may be applied will now be described in detail with reference to the accompanying drawings.

As shown in FIG. 7, the lower crotch member 10 is an absorbing member disposed at a location from the abdominal region to the dorsal region of an animal with the lower crotch region of the animal as the center, and it serves to absorb and hold excreta such as feces and urine that are discharged from the animal. The absorbing member is not particularly restricted and may be a disposable diaper or (light) incontinence pad, for example. As shown in FIG. 7, when it is worn, the lower crotch member 10 is used with both ends, the abdominal region side end E_{L3} located on the abdominal region side of the animal and the dorsal region side end E_{L4} located on the dorsal region side of the animal, engaged and fastened in a freely detachable with the anchoring surface of the non-torso-facing surface F₂ of the belt-shaped body 1.

FIG. 5 is a plan view of the lower crotch member 10 of an absorbent article for an animal in which the belt-shaped body of the invention can be applied, as viewed from the torso-facing surface side in the thickness direction, in the expanded state. As shown in FIG. 5, the lower crotch member 10 has an essentially rectangular longitudinal outer shape with a lengthwise direction L′ and a widthwise direction W′, in the plan view in the expanded state, and in the thickness direction, it has a first surface F₃ as the surface facing the torso of the animal (torso-facing surface) and a second surface F₄ as the surface on the side opposite the first surface F₃ (non-torso-facing surface) when the member is worn on the body of an animal.

The outer shape and outer dimensions of the lower crotch member are not particularly restricted, and any longitudinal outer shape (for example, rectangular, elliptical or hourglass-shaped) and outer dimensions may be employed, depending on the type and body frame and size of the animal that is to wear it.

As shown in FIG. 5, the lower crotch member 10 comprises, as the basic construction in the thickness direction, a liquid-permeable top sheet 11 situated on the torso-facing surface side of the lower crotch member 10, a liquid-impermeable back sheet 12 situated on the non-torso-facing surface side of the lower crotch member 10, and an absorbent body 13 situated between these sheets and extending in a manner straddling, in the lengthwise direction L′, the lengthwise center axis line C′_{W} that runs in the widthwise direction W′, while extending in a manner straddling, in the widthwise direction W′, the widthwise center axis line C′_{L} that runs in the lengthwise direction L′, based on the plan view of the lower crotch member 10, the construction being such that excreta such as feces and urine that have been discharged by the animal can be absorbed and held by the absorbent body 13 while penetrating in the thickness direction.

Also, as shown in FIG. 5, the lower crotch member 10 further comprises engaging members (an abdominal region side engaging member 17 and dorsal region side engaging member 18) disposed on the first surface F₃ of each of both ends in the lengthwise direction L′ of the lower crotch member 10 (i.e., the abdominal region side end E_{L3} and the dorsal region side end E_{L4}), a tail opening 19 for insertion of the tail of the animal, disposed at a location between the absorbent body 13 and the dorsal region side end E_{L4} in the plan view, and overlapping with the widthwise center axis line C′_{L}, a pair of side sheets 14 disposed on the torso-facing surface side of the top sheet 11 and sandwiching the widthwise center axis line C′_{L}, gather-forming elastic members 15 disposed on the inner side ends in the widthwise direction of the side sheets 14 and running in the lengthwise direction L′, and elastic members 16 disposed on the outer sides in the widthwise direction of the absorbent body 13, sandwiching the absorbent body 13 in the plan view, in such a manner as to allow steady fitting onto the lower crotch of the animal while preventing outward leakage of excreta such as feces and urine that have been discharged from the animal.

The lower crotch member of the absorbent article for an animal to which the belt-shaped body of the invention may be applied is not limited to this aspect, and the belt-shaped body of the invention may be applied to any lower crotch member suited for the type, body frame and size of the animal on which it is to be fitted.

Moreover, the belt-shaped body of the invention is not restricted to the embodiments described above and can incorporate appropriate combinations, substitutions and modifications within a range that is not outside of the object and gist of the invention. Incidentally, the ordinal terms “first” and “second” as used throughout the present description serve merely to distinguish between the numbered embodiments and are not used to mean any relative ordering, precedence or importance.

### REFERENCE SIGNS LIST

1 Belt-shaped body
2 Inner surface member
3 Outer surface member
4 Core member
5 Loop member (first engagement section)
6 Hook member (second engagement section)
7 Gripping part
71 Non-engagement section
72 Hook member (third engagement section)
8 Engaging section on non-torso-facing surface side
9 Rigidity reinforcing member
10 Lower crotch member (disposable diaper for animal)

1. A belt-shaped body that has a lengthwise direction that corresponds to a direction around a torso of an animal and a widthwise direction that corresponds to a front-rear direction of the animal, that is reusable for anchoring of a lower crotch member that is to be disposed at a lower crotch of the animal, and that is a freely detachable, the belt-shaped body comprising:
a torso-facing surface that faces the torso of the animal when the belt-shaped body is worn;
a non-torso-facing surface on an opposite side from the torso-facing surface;
a center region located at a center in the lengthwise direction and that corresponds to an abdominal region of the animal when the belt-shaped body is worn;
a first region extending between one side edge in the lengthwise direction and the center region and that corresponds to a dorsal region of the animal when the belt-shaped body is worn;
a second region extending between another side edge in the lengthwise direction and the center region and that corresponds to the dorsal region of the animal when the belt-shaped body is worn;
a first engagement section that is disposed on the torso-facing surface of the first region;
a second engagement section that is disposed on the non-torso-facing surface of the second region and that engages with the first engagement section; and
a gripping part that has a length in the lengthwise direction such as to allow gripping between the one side edge in the lengthwise direction and the first engagement section and that does not engage with the second engagement section.

2. The belt-shaped body according to claim 1, wherein the second engagement section has a smaller length in the lengthwise direction than a length in the widthwise direction.

3. The belt-shaped body according to claim 1, wherein the second engagement section has a plurality of engaging protrusions that protrude from the non-torso-facing surface.

4. The belt-shaped body according to claim 1, wherein the gripping part comprises a third engagement section that engages with an engaging section on the non-torso-facing surface side, located further toward an inner side in the lengthwise direction than the second engagement section, on the torso-facing surface.

5. The belt-shaped body according to claim 4, wherein the third engagement section has a smaller length in the lengthwise direction than a length in the widthwise direction.

6. The belt-shaped body according to claim 4, wherein the third engagement section has a plurality of engaging protrusions that protrude from the non-torso-facing surface.

7. The belt-shaped body according to claim 4, wherein the engaging section on the non-torso-facing surface side extends from a lengthwise inside edge of the second engagement section in the lengthwise direction and passes beyond a lengthwise center axis that is in the widthwise direction of the belt-shaped body.
